(19) United States
(12) Patent Application Publication
(10) Pub. No.: US 2023/0004326 A1
(43) Pub. Date: Jan. 5, 2023

(54) STORAGE SYSTEM CONTROL METHOD AND STORAGE SYSTEM

(71) Applicant: Hitachi, Ltd., Tokyo (JP)

(72) Inventor: Tsuneyuki Imaki, Tokyo (JP)

(73) Assignee: Hitachi, Ltd., Tokyo (JP)

(21) Appl. No.: 17/684,496

(22) Filed: Mar. 2, 2022

(30) Foreign Application Priority Data
Jul. 2, 2021 (JP) 2021-110549

(51) Int. Cl. G06F 3/06; G06F 12/0891; G06F 12/084

(52) U.S. Cl. CPC G06F 3/0659; G06F 3/0619; G06F 3/0683; G06F 12/0891; G06F 12/084

(57) ABSTRACT

The storage system control method is implemented by a controller of a storage system. The method includes a step of storing data on a storage in a shared memory as cache data, a step of changing the cache data based on a writing request from outside, and a writeback step of writing back dirty cache data as the cache data which have been changed based on the writing request to the storage. The method further includes a step of storing the dirty cache data in a writeback processing memory prior to the writeback step. The writeback processing memory requires time for executing the writeback data process shorter than time required by the shared memory.

### BACKGROUND

The present invention relates to a storage system control method and a storage system.

The technique for access to the volume using the cache memory has been disclosed in WO 2015/087424. In the technique as disclosed in the document, the host device is provided with the expansion VOL that is not associated (mapped) with the final storage medium so that the access from the host device to the expansion VOL is accepted. The data written to the expansion VOL are compressed online using the cache memory, and the compressed data are associated with the compression VOL as the volume associated with the final storage medium. Simultaneously, the mapping information with respect to the area on the expansion VOL to which the data have been written, and the position on the compression VOL at which the compressed data of the written data are associated is maintained and managed. Upon reception of the reading request to the expansion VOL from the host device, the position information on the expansion VOL, which has been designated by the reading request is converted into the position information of the final storage medium based on the mapping information. The compressed data are then read out on the cache memory from the final storage medium. The compressed data are expanded using the cache memory, and transferred to the host device.

### SUMMARY

In the structure in which the controller associated with the storage includes the cache memory, and compresses the cache data which have been changed based on the writing request for writeback to the storage, the writing operation can be executed at high speeds. The structure, however, fails to manage and expand the processor and the memory separately.

The processor and the memory can be managed and expanded separately by connecting the controller to the shared memory for storing the cache data therein in the heterogeneous connection environment, resulting in structural flexibility. The structure, however, prolongs the time taken for the controller to read and compress the cache data in the shared memory until the writeback operation.

It is an object of the present invention to provide the storage system with high structural flexibility and high writeback processing performance.

The storage system control method according to the present invention as a representative example is implemented by a controller of a storage system. The method includes a step of storing data on a storage in a shared memory as cache data, a step of changing the cache data based on a writing request from outside, and a writeback step of writing back dirty cache data as the cache data which have been changed based on the writing request to the storage. The method further includes a step of storing the dirty cache data in a writeback processing memory prior to execution of the writeback step. The writeback processing memory requires time for executing a writeback data process shorter than time required by the shared memory.

A representative example of the storage system according to the present invention includes a storage for storing data, a controller for processing data stored in the storage, a first memory which allows access from multiple controllers, and a second memory which allows access from at least one controller. The controller stores data on the storage in the first memory as cache data, changes the cache data based on a writing request from outside, stores dirty cache data in the second memory as the cache data which have been changed based on the writing request, executes a process for writing back the dirty cache data stored in the second memory and subjected to a predetermined data process to the storage. The second memory requires time for executing the predetermined data process shorter than time required by the first memory.

The present invention provides the storage system with high structural flexibility and high writeback processing performance. Problems, structures, and advantageous effects other than those described above will be clarified by the following description of the embodiment.

### BRIEF DESCRIPTION OF THE DRAWINGS

FIG. 1 is an explanatory view of a first structure and an operation of a storage system;

FIG. 2 is an explanatory view of a second structure and an operation of the storage system;

FIG. 3 is an explanatory view of a third structure and an operation of the storage system;

FIG. 4 illustrates a structure of the storage system;

FIG. 5 is an explanatory view of a functional structure of a controller;

FIG. 6 represents a specific example of a cache management method configuration file;

FIG. 7 represents a specific example of a cache management table;

FIG. 8 is a flowchart representing a process procedure executed by a cache management method control unit;

FIG. 9 is a flowchart representing a detailed storage data reading process;

FIG. 10 is a flowchart representing a detailed dirty cache redundancy process;

FIG. 11 is a flowchart representing a detailed dirty cache preceding storage process; and

FIG. 12 is a flowchart representing a detailed cache writeback process.

### DETAILED DESCRIPTION

An embodiment will be described referring to the drawings.

### Embodiment

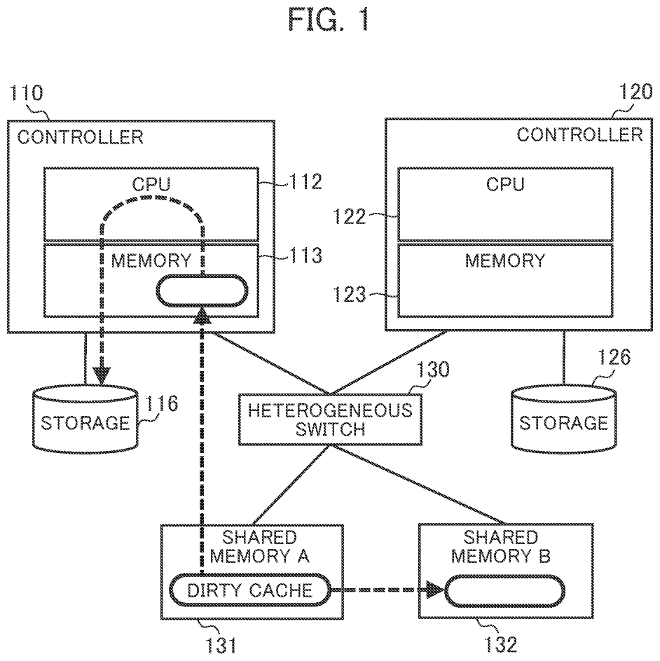

A structure and an operation of the storage system of the embodiment will be described. FIG. 1 is an explanatory view of a first structure and an operation of the storage system.

A controller 110 as shown in FIG. 1 as a node of the storage system allows a not shown host computer to execute reading from/writing to a storage 116. The controller 110 is connected to shared memories A 131 and B 132 via a heterogeneous switch 130.

Similarly, a controller 120 as a node of the storage system allows the not shown host computer to execute reading from/writing to a storage 126. The controller 120 is connected to the shared memories A and B via the heterogeneous switch 130.

The controller 110 includes a CPU (Central Processing Unit) 112 and a memory 113. The CPU 112 is a processor for executing data processing that involves access to the storage 116.

The controller 110 stores cache data to be read from/written to the storage 116 in the shared memory A. The use of the shared memory A as the cache memory for storing the cache data improves latency of the access from the host computer. As the shared memory connected in the heterogeneous environment is used as the cache memory, the processor and the memory can be separately managed and expanded, resulting in the structural flexibility.

Upon acceptance of the writing request from the host computer, the controller 110 changes the cache data in the shared memory A. The cache data changed based on the writing request become dirty cache data which do not match data on the storage 116. The dirty cache data are written back to the storage 116 based on a sync request from the host computer, for example.

Upon generation of the dirty cache data based on the writing request, the controller 110 copies the dirty cache data to the shared memory B for performing a redundancy operation. Prior to the writeback to the storage 116, the dirty cache data are stored in the memory 113 of the controller 110.

The time required for the memory 113 of the controller 110 to execute the writeback data process is shorter compared with the shared memory A. Execution of the writeback while having the dirty cache data temporarily stored in the memory 113 improves the writeback latency to be better than execution of the writeback by directly reading the dirty cache data from the shared memory A. That is, the memory 113 is used as a writeback processing memory which needs not hold the cache data requiring no writeback (read cache). Accordingly, the required capacity of the memory 113 can be made significantly smaller than that of the shared memory A used as the cache memory.

Upon the writeback operation, the CPU 112 reads the dirty cache data from the memory 113, and executes the writeback data process so that the data are written to the storage 116. The writeback data process may be exemplified by data compression, for example. If the storage 116 is configured to hold the compressed data, the CPU 112 compresses the data to be written to the storage 116, and writes the compressed data to the storage 116. Upon execution of the reading process from the storage 116, the CPU 112 reads the compressed data from the storage 116, and stores the data in the cache memory.

The dirty cache data in the shared memory A may be stored in the memory 113 at the timing after acceptance of the writeback request, that is, the sync request. The dirty cache data may be stored in the memory 113 before accepting the sync request, that is, prior to the sync request. If the dirty cache data are stored in the memory 113 precedingly, the dirty cache data need not be made redundant for the shared memory B because the dirty cache data can be made redundant by the shared memory A and the memory 113.

The controller 120 includes a CPU 122 and a memory 123. Operations of the controller 120 are the same as those of the controller 110, and explanations thereof, thus will be omitted.

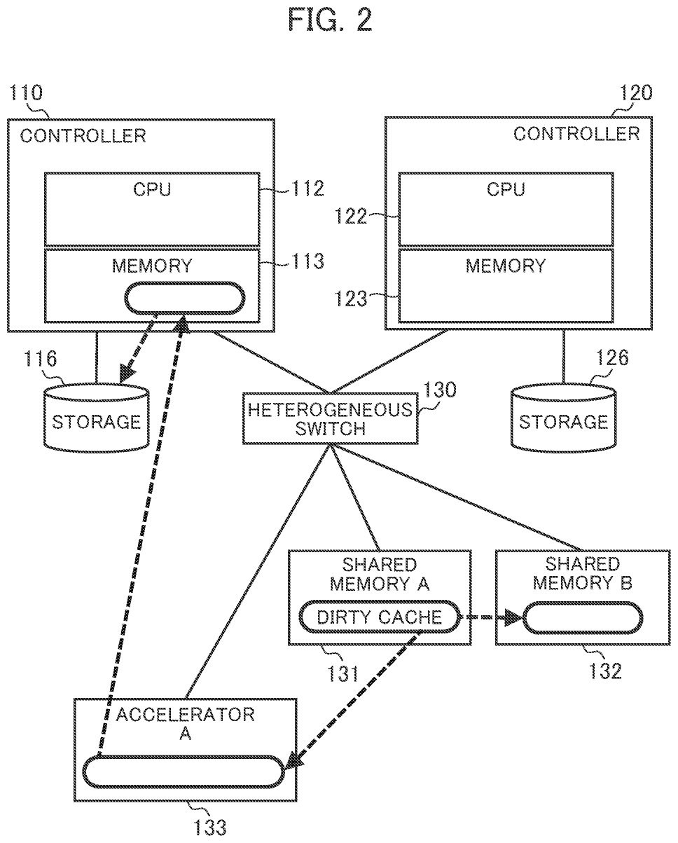

FIG. 2 is an explanatory view of a second structure and an operation of the storage system. In the structure as illustrated in FIG. 2, the controllers 110 and 120 are further connected to an accelerator A 133 via the heterogeneous switch 130. Other structures are similar to those illustrated in FIG. 1.

In the structure as illustrated in FIG. 2, the controller 110 uses the shared memory A as the cache memory.

Upon generation of the dirty cache data in the shared memory A based on the writing request, the controller 110 copies the dirty cache data to the shared memory B for performing the redundancy operation. Prior to the writeback to the storage 116, the dirty cache data are stored in the memory of the accelerator A133.

The accelerator A 133 is a shared data processing device to be shared by multiple controllers, and configured to execute the writeback data process, for example, data compression.

Storage of the dirty cache data in the memory of the accelerator A 133 reduces the required data processing time to be shorter than the one taken by directly reading the dirty cache data from the shared memory A. Accordingly, the writeback latency can be improved. That is, the memory of the accelerator A 133 is used as the writeback processing memory so that the cache data (read cache) requiring no writeback operation need not be held. Therefore, the capacity required for the memory of the accelerator A 113 can be made significantly smaller than that of the shared memory A used as the cache memory.

Upon the writeback operation, the accelerator A 133 reads the dirty cache data from its memory to execute the writeback data process. The data processing results, for example, the compressed data are moved to the memory 113 of the controller 110, and written to the storage 116 without the data processing executed by the CPU 112.

The dirty cache data in the shared memory A may be stored in the memory of the accelerator A 133 at the timing after acceptance of the writeback request, that is, the sync request. The dirty cache data may be stored in the memory of the accelerator A 133 before accepting the sync request, that is, prior to the sync request. If the dirty cache data are stored in the memory of the accelerator A 133 precedingly, the dirty cache data need not be made redundant for the shared memory B because the dirty cache data can be made redundant by the shared memory A and the memory of the accelerator A 133.

The controller 120 includes the CPU 122 and the memory 123. Operations of the controller 120 are the same as those of the controller 110, and explanations thereof, thus will be omitted.

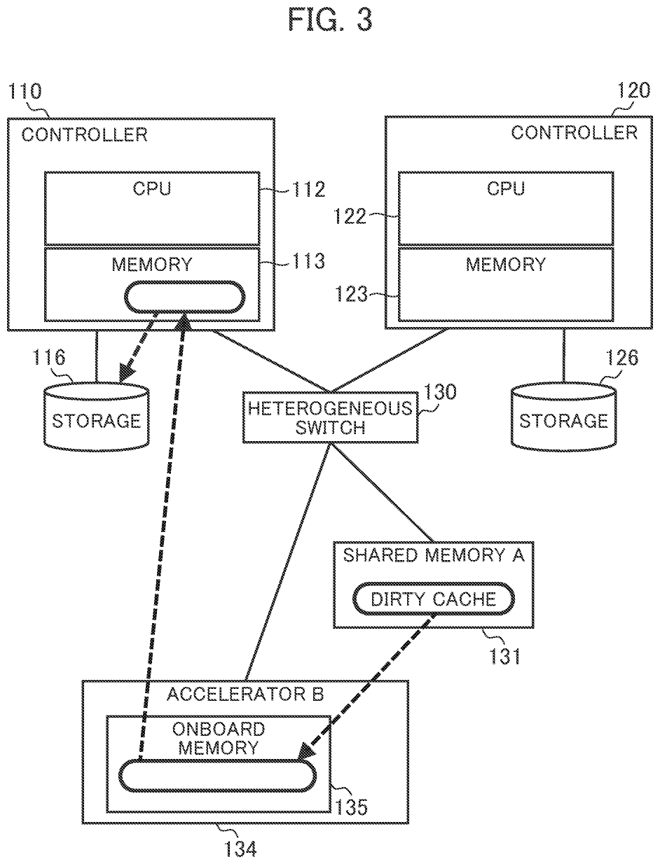

FIG. 3 is an explanatory view of a third structure and an operation of the storage system. In the structure as illustrated in FIG. 3, the controllers 110 and 120 are connected to the shared memory A 131 and an accelerator B 134 via the heterogeneous switch 130. The shared memory B is not required. The accelerator B 134 includes an onboard memory 135 with capacity that can be used for making the cache memory redundant. Other structures are similar to those illustrated in FIG. 1.

In the structure as illustrated in FIG. 3, the controller 110 uses the shared memory A as the cache memory.

Upon generation of the dirty cache data in the shared memory A based on the writing request, the controller 110 copies the dirty cache data to the onboard memory 135 of the accelerator B 134 for performing the redundancy operation. Prior to the writeback to the storage 116, the controller stores the dirty cache data in the onboard memory 135.

The accelerator B 134 is a shared data processing device to be shared by multiple controllers, and configured to execute the writeback data process, for example, data compression.

Storage of the dirty cache data in the onboard memory 135 of the accelerator B 134 reduces the required data processing time to be shorter than the one taken by directly reading the dirty cache data from the shared memory A. Accordingly, the writeback latency can be improved. That is, the onboard memory 135 is used as the writeback processing memory. The memory with sufficient capacity is allowed to hold the cache data (read cache) requiring no writeback operation.

Upon the writeback operation, the accelerator B 134 reads the dirty cache data from the onboard memory 135 to execute the writeback data process. The data processing results, for example, the compressed data are moved to the memory 113 of the controller 110, and written to the storage 116 without the data processing executed by the CPU 112.

The controller 120 includes the CPU 122 and the memory 123. Operations of the controller 120 are the same as those of the controller 110, and explanations thereof, thus will be omitted.

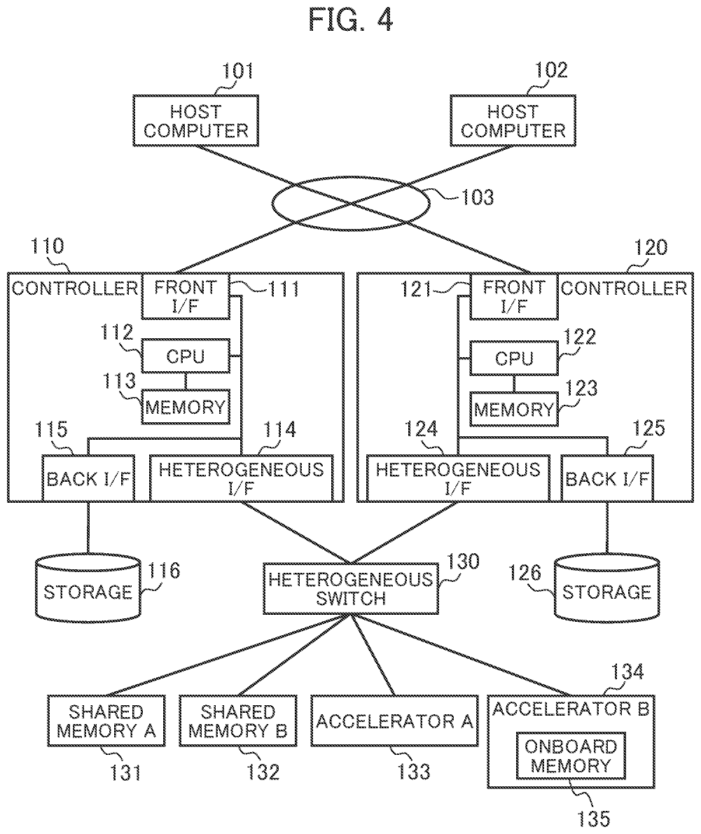

FIG. 4 illustrates a structure of the storage system. As FIG. 4 shows, the controllers 110 and 120 are connected to host computers 101 and 102 via a network 103.

The controller 110 includes a front I/F 111, the CPU 112, the memory 113, a heterogeneous I/F 114, and a back I/F 115. The memory 113 is connected to the CPU 112. The CPU 112 is bus connected to the front I/F 111, the heterogeneous I/F 114, and the back I/F 115.

The front I/F 111 is an interface for connection to the network 103. The heterogeneous I/F 114 is an interface for connection to the heterogeneous switch 130. The back I/F 115 is an interface for connection to the storage 116.

The heterogeneous switch 130 allows the controller 110 to be heterogeneously connected to the shared memories A 131, B 132, the accelerators A 133 and B 134.

The controller 120 includes a front I/F 121, the CPU 122, the memory 123, a heterogeneous I/F 124, and a back I/F 125. Since structures and operations of the controller 120 are the same as those of the controller 110, explanations, thus, will be omitted.

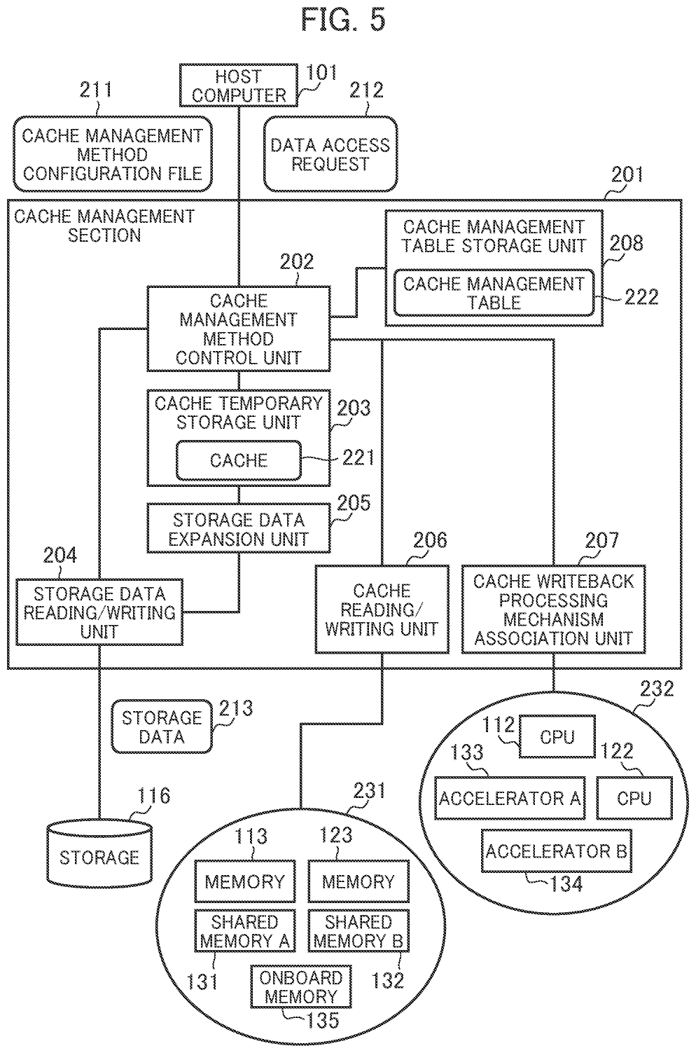

FIG. 5 is an explanatory view of functional structures of the controller 110. The CPU 112 of the controller 110 serves as a cache management section 201 by developing a predetermined program to be executed in the memory 113.

The cache management section 201 is constituted by functional parts including a cache management method control unit 202, a cache temporary storage unit 203, a storage data reading/writing unit 204, a storage data expansion unit 205, a cache reading/writing unit 206, a cache writeback processing mechanism association unit 207, and a cache management table storage unit 208.

The cache management method control unit 202 acquires a cache management method configuration file 211 from the host computer 101, and selects a cache control operation with reference to the cache management method configuration file 211. The cache control operation is performed using the writeback processing memory and the processor for executing the writeback data process (for example, data compression), which will be described in detail later.

Upon reception of a data access request 212 from the host computer 101, the cache management method control unit 202 processes the request by executing the cache control in accordance with the selected operation.

The cache temporary storage unit 203 serves as a processing unit which temporarily stores a cache 221.

The storage data reading/writing unit 204 serves as a processing unit which reads/writes storage data 213 from/to the storage 116.

The storage data expansion unit 205 expands the storage data read from the storage 116, and passes the data to the cache temporary storage unit 203 as the readout cache 221.

The cache reading/writing unit 206 reads/writes the cache from/to a cache storage medium 231. The cache storage medium 231 serves as a medium for storing the cache data and the dirty cache data, which is exemplified by the memories 113, 123, the shared memories A 131, B 132, the onboard memory 135, and the like.

The cache writeback processing mechanism association unit 207 is a functional part associated with a cache writeback processing mechanism 232. The cache writeback processing mechanism 232 serves to execute the writeback data process such as compression, which is exemplified by the CPUs 112, 122, the accelerators A 133, B 134, and the like.

The cache management table storage unit 208 stores a cache management table 222.

In the cache management table 222, a data ID for identifying data in the storage 116 is associated with a cache state.

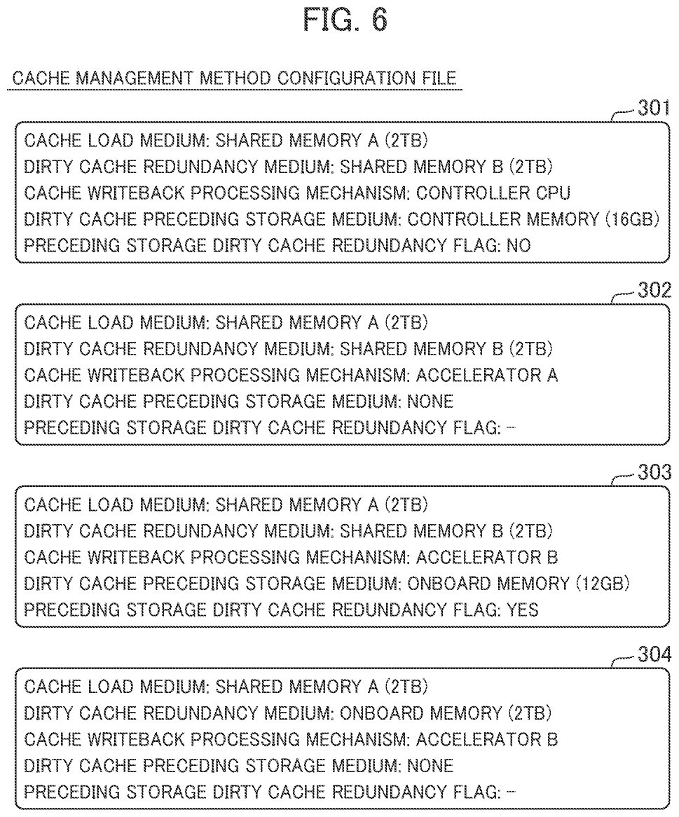

FIG. 6 represents a specific example of the cache management method configuration file 211. Referring to FIG. 6, an arbitrary configuration file is selected from configuration examples 301 to 304, and shared by the respective controllers of the storage system.

Each of the configuration examples 301 to 304 includes such items as “cache load medium”, “dirty cache redundancy medium”, “cache writeback processing mechanism”, “dirty cache preceding storage medium”, and “preceding storage dirty cache redundancy flag”.

The cache load medium serves as a cache memory which holds the data read from the storage and expanded as the cache data.

The dirty cache redundancy medium serves to store a copy of the dirty cache data among cache data in the cache load medium, which have been changed based on the writing request.

The cache writeback processing mechanism identifies the mechanism expected to execute the writeback data process such as compression.

The dirty cache preceding storage medium serves as a memory, in other words, a writeback processing memory for holding the dirty cache data prior to acceptance of the sync request.

The preceding storage dirty cache redundancy flag indicates whether or not the dirty cache data in the dirty cache data redundancy medium are cleared upon preceding storage of the dirty cache data prior to the sync request.

If the preceding storage dirty cache redundancy flag indicates NO, the dirty cache data stored in the dirty cache preceding storage medium are handled as redundancy data of the dirty cache data in the cache load medium. Accordingly, the dirty cache data stored in the dirty cache preceding storage medium are deleted from the dirty cache redundancy medium.

Meanwhile, if the preceding storage dirty cache redundancy flag indicates YES, the dirty cache data stored in the dirty cache preceding storage medium are kept stored in the dirty cache redundancy medium.

Referring to the configuration example 301 as shown in FIG. 6, the “shared memory A (2 TB)” serves as the cache load medium, the “shared memory B (2 TB)” serves as the dirty cache redundancy medium, the “controller CPU” serves as the cache writeback processing mechanism, the “controller memory (16 GB)” serves as the dirty cache preceding storage medium, and the preceding storage dirty cache redundancy flag indicates “NO”.

Referring to the configuration example 302 as shown in FIG. 6, the “shared memory A (2 TB)” serves as the cache load medium, the “shared memory B (2 TB)” serves as the dirty cache redundancy medium, the “accelerator A” serves as the cache writeback processing mechanism, no dirty cache preceding storage medium is used, that is, “none”, and the preceding storage dirty cache redundancy flag indicates “-”.

Referring to the configuration example 303 as shown in FIG. 6, the “shared memory A (2 TB)” serves as the cache load medium, the “shared memory B (2 TB)” serves as the dirty cache redundancy medium, the “accelerator B” serves as the cache writeback processing mechanism, the “onboard memory (12 GB)” serves as the dirty cache preceding storage medium, and the preceding storage dirty cache redundancy flag indicates “YES”.

Referring to the configuration example 304 as shown in FIG. 6, the “shared memory A (2 TB)” serves as the cache load medium, the “shared memory B (2 TB)” serves as the dirty cache redundancy medium, the “accelerator B” serves as the cache writeback processing mechanism, no dirty cache preceding storage medium is used, that is, “none”, and the preceding storage dirty cache redundancy flag indicates “-”.

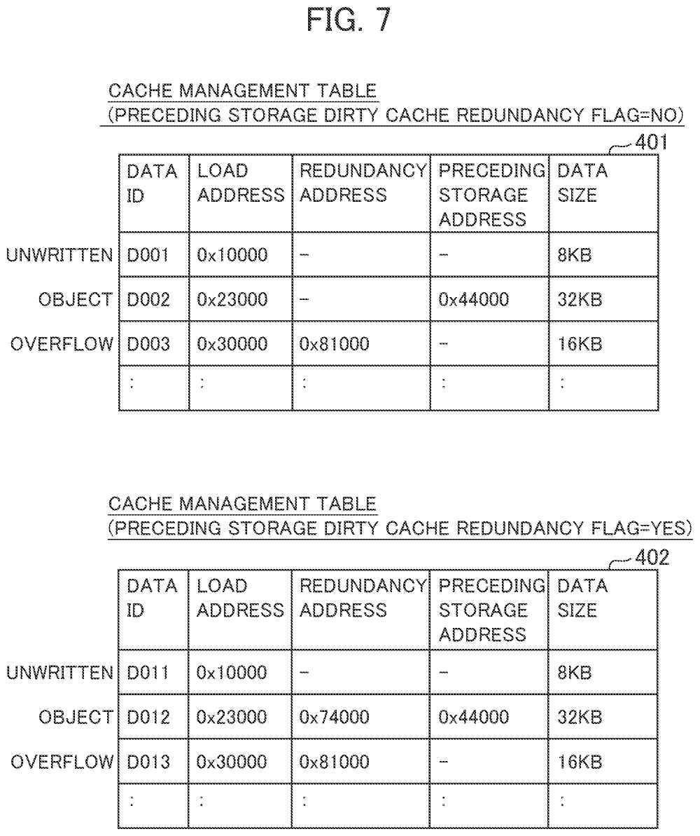

FIG. 7 represents a specific example of the cache management table. A specific example 401 of FIG. 7 represents an example of the cache management table 222 when the preceding storage dirty cache redundancy flag indicates “NO”. A specific example 402 represents an example of the cache management table 222 when the preceding storage dirty cache redundancy flag indicates “YES”.

The cache management table 222 includes such items as the data ID, a load address, a redundancy address, a preceding storage address, and a data size.

The data ID denotes identification information for identifying data on the storage.

The load address denotes an address of the cache data on the cache load medium.

The redundancy address denotes an address of the dirty cache data on the dirty cache redundancy medium.

The preceding storage address denotes an address of the dirty cache data on the dirty cache preceding storage medium.

The data size denotes size of data.

Referring to the specific example 401, when the preceding storage dirty cache redundancy flag indicates “NO”, the load address and the data size of the unwritten cache data are registered, while having the redundancy address and the preceding storage address kept unregistered.

Upon writing operation, the preceding storage address to be precedingly stored is added. However, the redundancy address is unregistered.

Upon occurrence of multiple writing operations before acceptance of the sync request to cause dirty cache data overflow from the dirty cache preceding storage medium, the overflown dirty cache data are copied to the dirty cache redundancy medium to clear the preceding storage address. The load address and the redundancy address of the overflown dirty cache data are registered, and the preceding storage address is unregistered.

Referring to the specific example 402, when the preceding storage dirty cache redundancy flag indicates “YES”, the load address and the data size of the unwritten cache data are registered while having the redundancy address and the preceding storage address kept unregistered.

Upon writing operation, the dirty cache data are copied to the dirty cache redundancy medium so that the redundancy address is registered, and the preceding storage address of the data to be precedingly stored is added.

Upon occurrence of multiple writing operations before acceptance of the sync request to cause dirty cache data overflow from the dirty cache preceding storage medium, the preceding storage address of the overflown dirty cache data is cleared. Accordingly, the load address and the redundancy address of the overflown dirty cache data are registered, and the preceding storage address is unregistered.

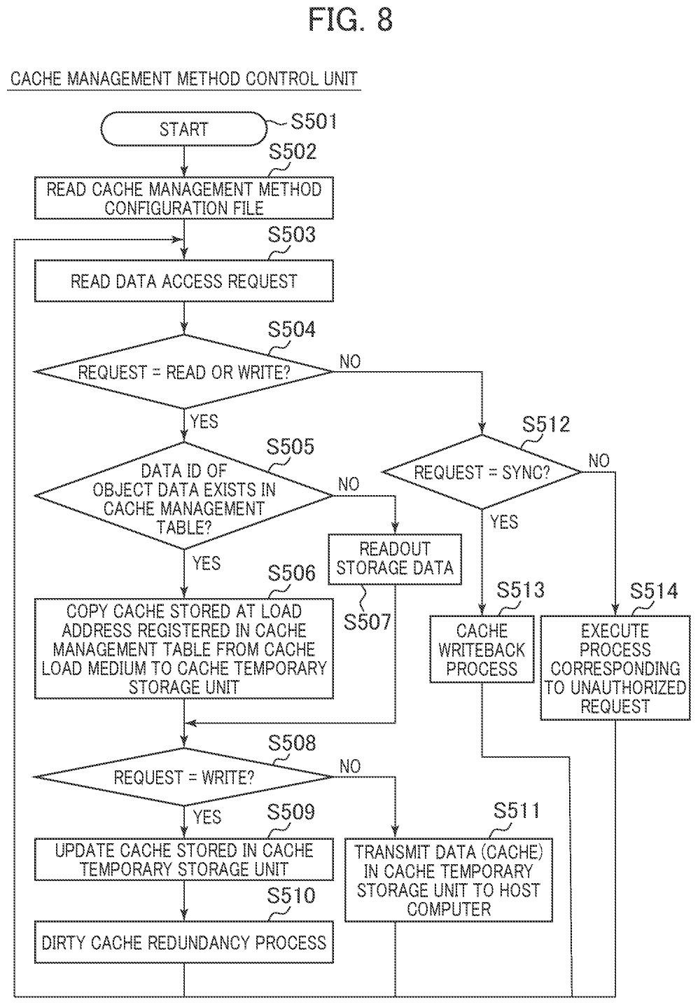

FIG. 8 is a flowchart representing a process procedure executed by the cache management method control unit. Upon start of the process (step S501), the cache management method control unit 202 reads the cache management method configuration file 211 (step S502).

When the data access request from the host computer is read, (step S503), the cache management method control unit 202 determines whether the request corresponds to reading (Read) or writing (Write) (step S504).

If the reading or writing request has been issued (YES in step S504), the cache management method control unit 202 determines whether or not the data ID of the object data exists in the cache management table 222 (step S505).

If the data ID of the object data exists in the cache management table 222 (YES in step S505), the cache management method control unit 202 copies the cache stored at the load address registered in the cache management table 222 from the cache load medium to the cache temporary storage unit (step S506).

If the data ID of the object data does not exist in the cache management table 222 (NO in step S505), the storage data reading/writing unit 204 reads the storage data (step S507).

Subsequent to step S506 or S507, the cache management method control unit 202 determines whether or not the writing request has been issued (step S508).

If the writing request has been issued (YES in step S508), the cache management method control unit 202 updates the cache in the cache temporary storage unit (step S509), and executes the dirty cache redundancy process (step S510). The process then returns to step S503.

If no writing request has been issued (NO in step S508), but the reading request has been issued, the cache management method control unit 202 transmits data (cache) in the cache temporary storage unit to the host computer (step S511). The process then returns to step S503.

If no writing request nor reading request has been issued (NO in step S504), the cache management method control unit 202 determines whether or not the sync request (Sync) has been issued (step S512).

If the sync request has been issued (YES in step S512), the storage data reading/writing unit 204 executes the cache writeback process (step S513). The process then returns to step S503.

If no sync request has been issued (NO in step S512), the cache management method control unit 202 executes the process corresponding to an unauthorized request (step S514). The process then returns to step S503.

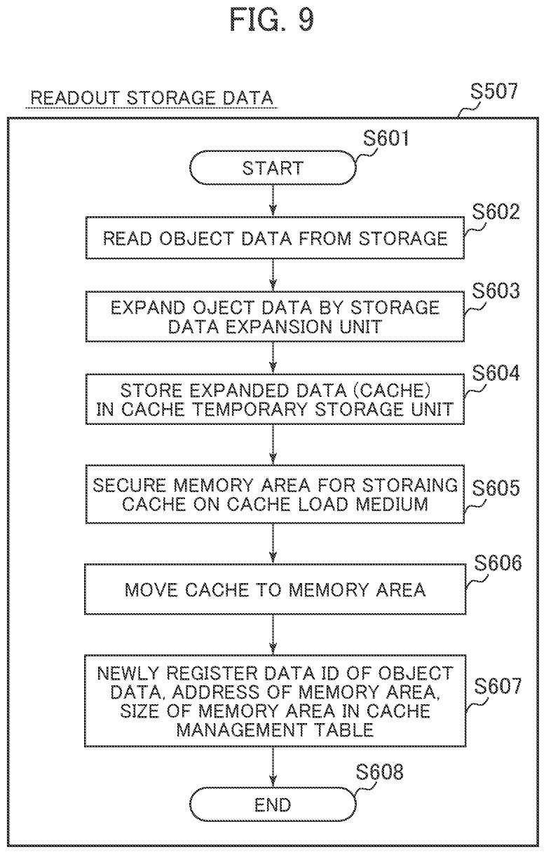

FIG. 9 is a flowchart representing a detailed storage data reading process. In other words, FIG. 9 represents a detailed process to be executed in step S507 as shown in FIG. 8.

Upon start of the storage data reading process (step S601), the storage data reading/writing unit 204 reads the object data from the storage (step S602), and the storage data expansion unit 205 expands the object data (step S603).

The storage data expansion unit 205 stores the expanded data (cache) in the cache temporary storage unit (step S604). The cache reading/writing unit 206 then secures a memory area for storing the cache on the cache load medium (step S605), and moves the cache to the memory area (step S606).

The cache management method control unit 202 newly registers the data ID of the object data, the address and the size of the memory area in the cache management table 222 (step S607). The storage data reading process is then terminated (step S608).

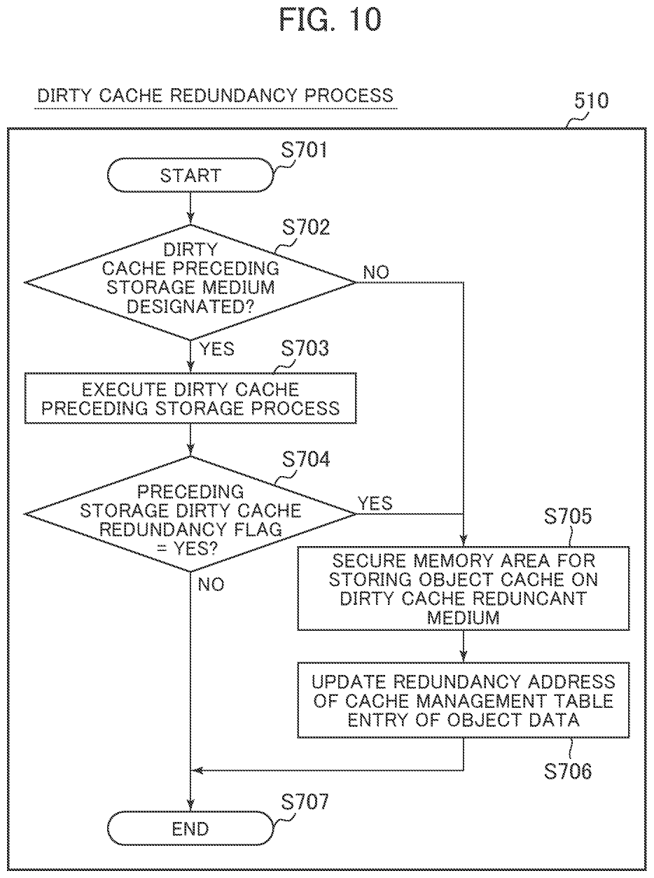

FIG. 10 is a flowchart representing a detailed dirty cache redundancy process. In other words, FIG. 10 represents a detailed process to be executed in step S510 as shown in FIG. 8.

Upon start of the dirty cache redundancy process (step S701), the cache management method control unit 202 determines whether or not the dirty cache preceding storage medium has been designated (step S702). If the dirty cache preceding storage medium has been designated (YES in step S702), the cache management method control unit 202 executes the dirty cache preceding storage process (step S703).

Subsequent to step S703, the cache management method control unit 202 determines whether or not the preceding storage dirty cache redundancy flag indicates YES (step S704). If the preceding storage dirty cache redundancy flag indicates NO (NO in step S704), the dirty cache redundancy process is terminated (step S707).

If the preceding storage dirty cache redundancy flag indicates YES (YES in step S704), or if the dirty cache preceding storage medium has not been designated (No in step S702), the cache reading/writing unit 206 secures the memory area for storing the object cache memory on the dirty cache redundancy medium (step S705), and updates the cache management table entry redundancy address of the object data (step S706). The dirty cache redundancy process is then terminated (step S707).

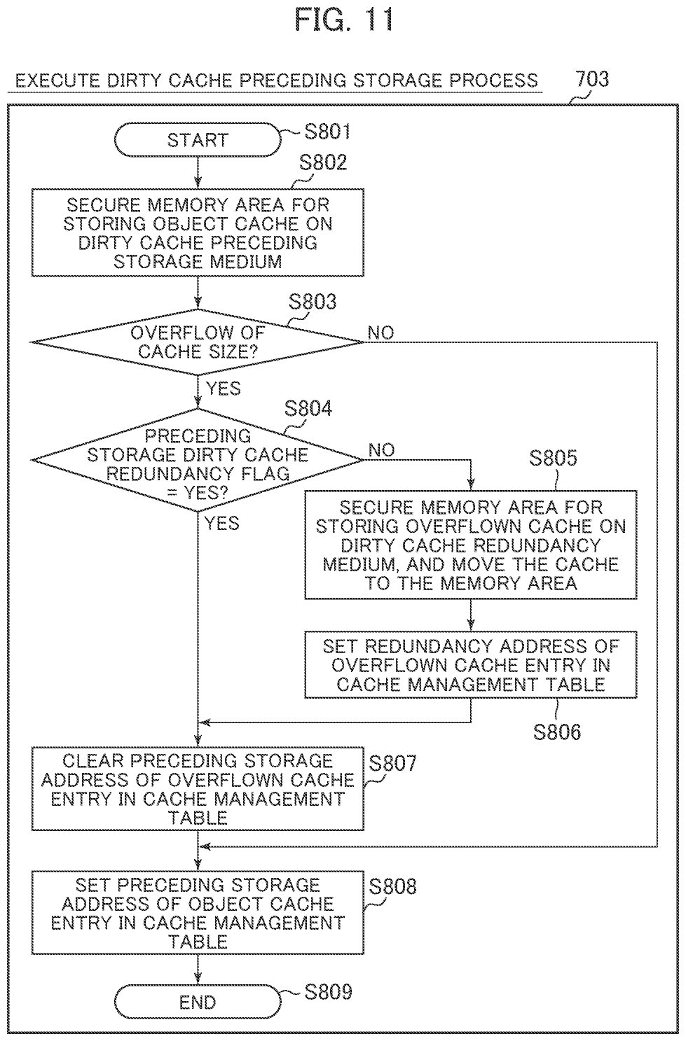

FIG. 11 is a flowchart representing a detailed dirty cache preceding storage process. In other words, FIG. 11 represents a detailed process to be executed in step S703 as shown in FIG. 10.

Upon start of the dirty cache preceding storage process (step S801), the cache management method control unit 202 secures the memory area for storing the object cache on the dirty cache preceding storage medium (step S802), and determines whether or not cache size overflow has occurred (step S803). Specifically, a total value of the data size of the dirty cache data is obtained. If the data size exceeds the capacity of the dirty cache preceding storage medium, it is determined that the cache size overflow has occurred.

If no cache size overflow has occurred (NO in step S803), the cache management method control unit 202 sets the preceding storage address of the object cache entry in the cache management table (step S808). The dirty cache preceding storage process is then terminated (step S809).

If the cache size overflow has occurred (YES in step S803), the cache management method control unit 202 determines whether or not the preceding storage dirty cache redundancy flag indicates YES (step S804).

If the preceding storage dirty cache redundancy flag indicates NO (NO in step S804), the cache management method control unit 202 secures the memory area for storing the overflown cache on the dirty cache redundancy medium, and moves the cache to the memory area (step S805). The cache management method control unit 202 then sets the redundancy address of the (overflown) cache entry in the cache management table 222 (step S806).

If the preceding storage dirty cache redundancy flag indicates YES (YES in step S804), or subsequent to step S806, the cache management method control unit 202 clears the preceding storage address of the (overflown) cache entry in the cache management table 222 (step S807). The cache management method control unit 202 then sets the preceding storage address of the object cache entry in the cache management table (step S808). The dirty cache preceding storage process is then terminated (step S809).

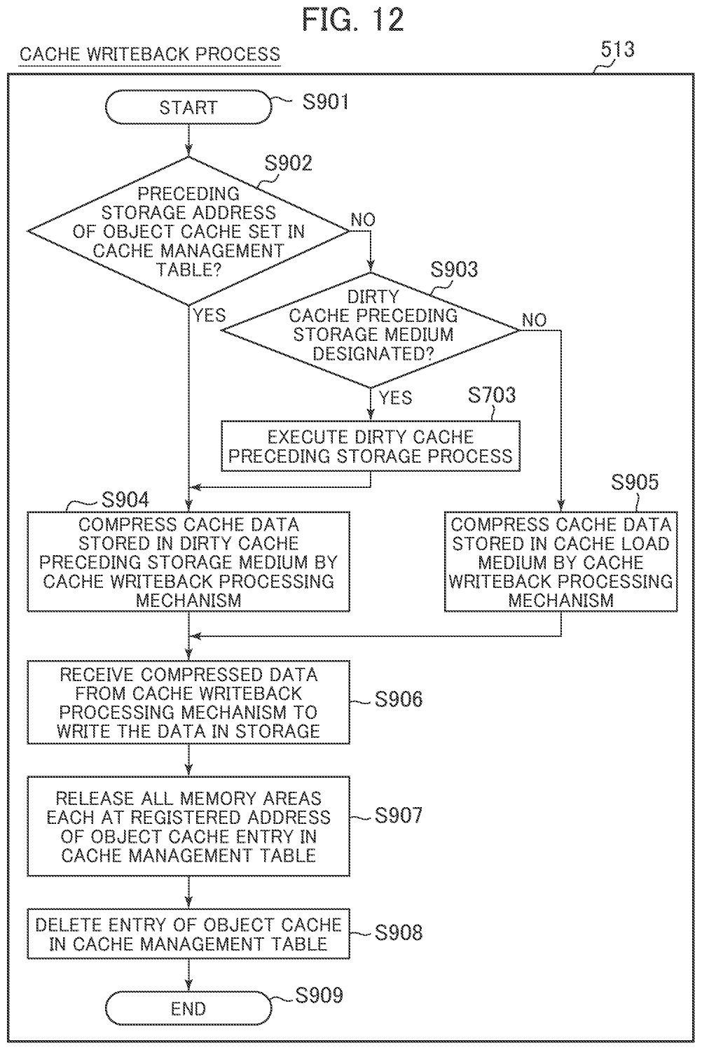

FIG. 12 is a flowchart representing a detailed cache writeback process. In other words, FIG. 12 represents a detailed process to be executed in step S513 as shown in FIG. 8.

Upon start of the cache writeback process (step S901), the cache management method control unit 202 determines whether or not the preceding storage address of the object cache has been set in the cache management table 222 (step S902).

If the preceding storage address of the object cache has been set in the cache management table 222 (YES in step S902), the process proceeds to step S904.

If the preceding storage address of the object cache has not been set in the cache management table 222 (NO in step S902), the cache management method control unit 202 determines whether or not the dirty cache preceding storage medium has been designated (step S903). If the dirty cache preceding storage medium has been designated (YES in step S903), the dirty cache preceding storage process (step S703) is executed. The process then proceeds to step S904. If the dirty cache preceding storage medium has not been designated (NO in step S903), the process proceeds to step S905.

In step S904, the cache data stored in the dirty cache preceding storage medium are compressed by the cache writeback processing mechanism (step S904).

In step S905, the cache data stored in the cache load medium are compressed by the cache writeback processing mechanism (step S905).

Subsequent to step S904 or S905, the cache writeback processing mechanism association unit 207 receives the compressed data from the cache writeback processing mechanism, and the storage data reading/writing unit 204 writes the data to the storage (step S906).

Subsequent to step S906, the cache management method control unit 202 releases all memory areas at the respective registered addresses of the object cache entry in the cache management table 222 (step S907), and deletes the object cache entry in the cache management table 222 (step S908). The cache writeback process is then terminated (step S909).

In the disclosed storage system, the controller 110 of the storage system executes the step of storing data on the storage in the shared memory as cache data, the step of changing the cache data based on the writing request from outside, and the writeback step of writing back dirty cache data as the cache data which have been changed based on the writing request to the storage. The controller further executes the step of storing the dirty cache data in the writeback processing memory prior to execution of the writeback step. The writeback processing memory requires time for executing the writeback data process shorter than time required by the shared memory.

The storage system with high structural flexibility and high writeback processing performance can be attained.

In the above-described structure, the controller 110 executes the writeback data process by copying the dirty cache data to another shared memory for performing the redundancy operation, and uses the memory of the controller as the writeback processing memory.

The structure allows improvement both in the structural flexibility and writeback latency while suppressing the number of devices that constitute the system.

In the above-described structure, the controller 110 copies the dirty cache data to another shared memory for performing a redundancy operation, and uses the memory of the shared data processing device as the writeback processing memory to allow the shared data processing device to execute the writeback data process.

In the structure, the shared data processing device is allowed to execute the writeback process such as compression. This makes it possible to improve both the structural flexibility and the writeback latency while lowering the processing load to the controller.

In the above-described structure, the controller 110 copies the dirty cache data to the memory of the shared data processing device for performing the redundancy operation, and makes the memory of the shared data processing device usable as the writeback processing memory to allow the shared data processing device to execute the writeback data process.

In the structure, the shared data processing device can be used as the shared memory. This makes it possible to improve both the structural flexibility and the writeback latency while suppressing the number of devices that constitute the system and lowering the load to the controller.

The controller is capable of storing the dirty cache data in the writeback processing memory prior to acceptance of the writeback request.

The above-described structure and operation allow further reduction in the time required for completion of the writeback operation from acceptance of the writeback request.

The controller may be configured to make the dirty cache data which have been precedingly stored in the writeback processing memory unapplicable to the redundancy operation for another storage medium.

The above-described structure and operation efficiently make the dirty cache data redundant while suppressing the usable capacity.

The controller selects the writeback processing memory and the processor for executing the writeback data process with reference to the preliminarily designated configuration information.

The structure allows appropriate selection of the cache-related operation in accordance with the system configuration.

The present invention is not limited to the above-described embodiment, but may be variously modified. The foregoing embodiment has been described in detail for readily understanding of the present invention which is not necessarily limited to the one equipped with all the structures as described above. It is possible to replace and add the structure as well as removal thereof.

In the foregoing embodiment, the writeback data processing is exemplified by compression. However, any other processing may be executed.

What is claimed is:

1. A storage system control method implemented by a controller of a storage system, the method comprising:
a step of storing data on a storage in a shared memory as cache data;
a step of changing the cache data based on a writing request from outside; and
a writeback step of writing back dirty cache data as the cache data which have been changed based on the writing request to the storage,
the method further comprising a step of storing the dirty cache data in a writeback processing memory prior to execution of the writeback step, the writeback processing memory requiring time for executing a writeback data process shorter than time required by the shared memory.

2. The storage system control method according to claim 1, wherein the controller executes the writeback data process by copying the dirty cache data to another shared memory for performing a redundancy operation, and uses a memory of the controller as the writeback processing memory.

3. The storage system control method according to claim 1, wherein the controller copies the dirty cache data to another shared memory for performing a redundancy operation, and uses a memory of a shared data processing device as the writeback processing memory to allow the shared data processing device to execute the writeback data process.

4. The storage system control method according to claim 1, wherein the controller copies the dirty cache data to a memory of a shared data processing device for performing a redundancy operation, and makes a memory of the shared data processing device usable as the writeback processing memory to allow the shared data processing device to execute the writeback data process.

5. The storage system control method according to claim 1, wherein the controller stores the dirty cache data in the writeback processing memory prior to acceptance of a writeback request.

6. The storage system control method according to claim 5, wherein the controller makes the dirty cache data which have been precedingly stored in the writeback processing memory unapplicable to a redundancy operation for another storage medium.

7. The storage system control method according to claim 1, wherein the controller selects the writeback processing memory and a processor for executing the writeback data process with reference to preliminarily designated configuration information.

8. The storage system control method according to claim 1, wherein the writeback data process is executed by compressing the dirty cache data.

9. A storage system, comprising:
a storage for storing data;
a controller for processing data stored in the storage;
a first memory which allows access from multiple controllers; and
a second memory which allows access from at least one controller, wherein:
the controller stores data on the storage in the first memory as cache data, changes the cache data based on a writing request from outside, stores dirty cache data in the second memory as the cache data which have been changed based on the writing request, executes a process for writing back the dirty cache data stored in the second memory and subjected to a predetermined data process to the storage; and
the second memory requires time for executing the predetermined data process shorter than time required by the first memory.
